(19) United States
(12) Patent Application Publication
(10) Pub. No.: US 2008/0272061 A1
(43) Pub. Date: Nov. 6, 2008

(54) Methods and Compositions for Deactivating Organic Acids in Oil

(75) Inventors: Paul Robert Hart, Sugar Land, TX (US); Tara Renee Cunningham, Pearland, TX (US)

Correspondence Address: MADAN, MOSSMAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 11/743,771

(22) Filed: May 3, 2007

(51) Int. Cl. B01D 17/00

(52) U.S. Cl. 210/749; 252/182.32

(57) ABSTRACT

Certain metal and metal-like hydroxides may be added to hydrocarbons with an immiscible and/or more volatile non-hydrocarbon phase to reduce the acidic potential of hydrocarbons with respect to downstream storage, transport, and processability once the non-hydrocarbon phase is removed. These metal hydroxides reduce TAN stoichiometrically and permanently while improving the demulsibility of the oil. A particularly effective metal hydroxide is lithium hydroxide and a particularly easy solvent to remove is water.

### TECHNICAL FIELD

The present invention relates to methods and compositions for deactivating organic acids in hydrocarbons, and more particularly relates, in one non-limiting embodiment, to methods and compositions for reducing the acidic potential of naphthenic acids, as measured by total acid number (TAN), in oil using metal hydroxides.

### TECHNICAL BACKGROUND

All crude oil contains impurities which can contribute to corrosion, heat exchanger fouling, furnace coking, catalyst deactivation and product degradation in refining and other processes. Many of these impurities are acidic, for instance many petroleum crude oils with high organic acid content, such as whole crude oils containing naphthenic acids, are corrosive to the equipment used to extract, transport and process the crude, such as pipestills and transfer lines. The acidity of the acid impurities in crude oil and other hydrocarbons is often measured as an acid number or total acid number (TAN), which is defined as the amount of potassium hydroxide in milligrams that is needed to neutralize the acids in one gram of oil. The TAN value indicates to a crude oil refinery the potential of corrosion problems that may be encountered in processing the particular crude oil. Many and various efforts have been undertaken to reduce the presence of acidic components, in particular the naphthenic acids, which are generally the main contributor to the TAN value. In many non-restrictive cases, it is desirable to reduce TAN below 1.

It has been suggested to treat acidic crude oils or fractions thereof to reduce or eliminate their acidity and corrosivity by the addition of suitable amounts of Group IA or Group IIA oxides, hydroxides or hydrates. The process has been contended to reduce materials handling problems associated with treating acidic crude oils using liquid solvents and in reducing emulsion formation. However, this technology, which involves calcium oxide, hydroxide, or hydroxyhydrates, requires the reagent to be added after all water separation units. Only in this way can divalent fouling cations such as Ca⁺² and monovalent emulsifying cations such as K⁺¹ be used that, in fact, would be incompatible with the upstream oil-water separation units. More importantly, by not removing the water added by these reagents (even dry metal oxide forms water upon reaction with organic acid), the naphthenate so formed metathesizes back into the naphthenic acid under subsequent high temperature vacuum distillation, and goes overhead into the vacuum gas oil (VGO) cut, presenting a corrosion danger to the line. There is no evidence that this technology (adding metal oxides after oil-water separation) reduces real acidic potential of the hydrocarbon, by which is meant the ability or tendency to form acidic species in subsequent storage, transport, or processing. It would appear to only deceive or subvert the test used to anticipate the problems.

It would thus be desirable if a simple, economical procedure for truly reducing the acidic potential, as represented by TAN, of a hydrocarbon could be devised.

### SUMMARY

There is provided, in one non-limiting embodiment a method for reducing the true acidic potential, as represented by total acid number (TAN), of a hydrocarbon that involves contacting a mixture of water and hydrocarbon having a naphthenic acid based TAN with a metal hydroxide reagent, or equivalent, in an amount effective to reduce TAN. Equivalents include, but are not necessarily limited to, monovalent or polyvalent metal hydroxides, or monomeric or polymeric 40 ammonium hydroxides, or the corresponding oxides, carbonates and thio and alkyl analogs of these hydroxides. The metal hydroxide is permitted to contact the acid components of the hydrocarbon sufficiently to reduce the TAN. In so doing, the acid converts the hydroxide of the metal (HO⁻) to water (H₂O). The water is then removed in a liquid-liquid separation vessel, leaving a hydrocarbon with reduced TAN and at least some non-hydrated (anhydrous) metal-acid anion, or dimer thereof. In a broader sense, the reagent contacts the hydrocarbon and is at least partly converted into a material of the non-hydrocarbon phase (e.g. water or equivalent).

Further, there is provided in another non-restrictive version a hydrocarbon composition having a reduced TAN that includes a hydrocarbon and a non-hydrated (anhydrous), metal-acid anion or 4° ammonium acid anion, or dimer thereof, such compositions being more stable toward precipitation from the hydrocarbon or emulsification of the hydrocarbon, and/or breakdown to regenerated acid in high temperature vacuum distillation, compared to the corresponding hydrocarbon containing only hydrated (hydrous) metal- or 4° ammonium acid anions.

As defined herein, the non-hydrocarbon phase comprises water, CO₂, H₂S, lower alcohols, ethers, esters, aldehydes, and ketones and mixtures thereof immiscible with or more volatile than the hydrocarbon. In one non-limiting embodiment, the reagent reacts with at least one acidic impurity or component giving at least one by-product that is a material of the non-hydrocarbon phase, e.g. water.

### DETAILED DESCRIPTION

The purpose of the methods and compositions herein is the reduction of acidic potential, as measured by TAN, in hydrocarbons, particularly crude oils. It has been surprisingly discovered that this goal may be accomplished without causing emulsions or undue harm to the downstream processability of the oil.

The active reagents or additives to reduce the corrosion caused by TAN in hydrocarbons include, but are not necessarily limited to, metal and quaternary (4°) ammonium hydroxides. One particularly useful monovalent metal hydroxide is lithium hydroxide, LiOH. While some polyvalent metal hydroxides and polymeric 4° ammonium hydroxides will reduce the acidic potential, as measured by TAN, they may also cause deposits to form, e.g. Ca naphthenates. Such polyvalent metal hydroxides or polymeric 4° ammonium hydroxides may be useful if a dispersant was also employed to alleviate any harmful deposition.

Another non-restrictive embodiment involves using hydroxides of mono-valent metals with tighter binding to carboxylate groups than fouling, polyvalent metals such as Ca. Li, for example, is thought to bind tighter than Ca whereas others in its class, such as Na and K, are more loosely associated (more easily dissociated) than Li and Ca carboxylate salts. Li salts can be added to capture or bind up the carboxylate-based TAN to prevent the formation of Ca naphthenates, which may be an attractive possibility. Hydroxides of monovalent heavy metals such as Cu, Ag and Au may be useful, although the cost of these materials would be greater. Thus, although LiOH is mentioned and discussed herein as one effective reagent or additive, it should be understood that the invention is not necessarily limited to this material.

Anions delivering hydroxide, such as oxide, carbonate or bicarbonate, which form hydroxide upon protonation and/or release of resultant carbon dioxide (CO₂) are here considered equivalent to hydroxide for the purpose of this process. Also the use of thio analogs of hydroxide, such sulfides (HS⁻), or anions delivering sulfide, to form hydrogen sulfide (H₂S) which is then removed, is considered equivalent to using metal hydroxides (HO⁻) to form water (H₂O), which is then removed. Alkyl analogs of hydroxides can also be used, for example, methoxide with the subsequent removal of the resultant methanol. In these cases where non-aqueous reaction products are created, the subsequent separation unit would be appropriate to the species being removed, for example, a distillation or degassing unit in the case of CO₂, H₂S or MeOH leaving groups.

TAN is reduced stoichiometrically with the additive. In general, TAN of a crude oil need only be reduced to below 1 (mg KOH/g sample) to meet most uses and specifications, thus in one non-limiting embodiment, the amount of additive or reagent should be at least equivalent to 0.1 mg KOH/g sample (the unit of TAN). In another non-restrictive version, the amount of reagent or additive may be the amount to reduce TAN of the hydrocarbon to between about 0.1 and about 0.9 mg KOH/g sample, where about 0.8 mg KOH/g sample may be a suitable target in many situations. Using a super-stoichiometric amount (greater than 1:1) may not cause harm, however the excess amount of additive or reagent may cause troublesome side reactions since it would not be consumed by the acid present.

The conditions for adding the metal hydroxides will depend on the particular hydrocarbon, the particular TAN of the hydrocarbon, the logistics of the system or production process involved and the end use or shipment specifications. It has been found that the metal hydroxide reacts most quickly and most completely when it is added to the hydrocarbon in methanol. However, LiOH is only about 2% soluble in methanol, thus using methanol as a solvent tends to add considerable methanol to the hydrocarbon. The methanol can be removed by distillation, but this requires considerable energy. In current facilities, most of this methanol would be removed with entrained water in liquid-liquid separation units. But there can be a penalty for the methanol in the water added as it adds to the COD load in the wastewater plant. These costs and penalties are still not as high as the TAN penalty in most situations.

The metal hydroxide may also be added in a water solution. LiOH is 11% soluble in water, though solutions may precipitate insoluble carbonates upon exposure to air. With respect to LiOH, the least expensive method to ship and store it is as a powder, in bags or other convenient container. The containers for such a metal hydroxide form would need to be opened and diluted or dispersed into the oil and water, thus requiring equipment, labor, and exposure. It does not matter how much or whether water is added with the reagent, because it is added to the production process before and/or in the last oil-water separator, so any added water will be removed in the separator with the preexisting (produced) water.

In one non-limiting embodiment of the method herein, the hydrocarbon production fluid to be treated is passed or processed through a series of units, which includes at least one oil/non-oil phase separator, said non-oil phase including the product formed by reaction of the reagent with the acidic species in the oil. For example, an oil/water liquid-liquid separator might follow the addition of a metal hydroxide reagent. The reagent, additive or agent is, in one non-limiting embodiment, added to, introduced into, or contacted with the hydrocarbon prior to and/or at the last oil/non-oil phase separator in the series of unit operations. The non-oil phase is then removed in this separator. Included in that phase is the product formed by reaction of the acid in the oil with the reagent. For example the water from the neutralization with hydroxide partitions into the produced water being separated. Unlike prior methods, the reaction product herein does not cause fouling or emulsification upon contact with oil or water, but rather serves to prevent these phenomena. Only the dry (anhydrous) metal naphthenate or its dimer (RCOOM-MOOCR) remains in the oil, so that upon heating under vacuum it cannot metathesize back to the acid and go overhead into the VGO.

The metal hydroxide reagent thus may also be seen to act as a demulsifier. In one non-limiting explanation, this may be because of the close association of the reagent metal with the naphthenate group, essentially replacing the protons of the carboxylic acid dimer complex in the oil, rather than simply removing it and forming a monomeric, dissociated soapy anion, such as sodium or potassium naphthenate do, although the inventors do not wish to be bound by any particular theory. Since the reagent or additive also acts as a demulsifier, the water added with the metal hydroxide is further induced to drop out in the water-oil separator. In implementation, if another demulsifier is normally used, it may need to be changed or its dosage adjusted when the methods and compositions herein are implemented or present. Surprisingly, the metal hydroxides herein reduced the tendency of the oil to emulsify with the water present, both relative to adding nothing as well as to adding alternative reagents, e.g. more dissociating hydroxides such as NaOH and KOH.

The use of monovalent metals avoids the polymerization by di- or poly-valent metals of di- or poly-valent naphthenates into insoluble deposits that foul the units processing them. Metals like Ca, Mg, Fe, and Zn are known to form intractable deposits from oils containing of di- and especially tetra-naphthenic acids. Mono-valent metals do not form such deposits. One non-limiting explanation of this is that monovalent metals are not able to bridge two naphthenates and so form an infinite matrix.

If the metal hydroxide is added as a powder or solid particulate, adding it upstream of one or more oil-water separators has the additional advantage of allowing more time and turbulence for the powder to dissolve and react.

The compositions and methods described above will now be further illustrated by the following experiments and examples which are simply intended to supplement and specifically illuminate these compositions and methods without limiting them in any way.

### EXPERIMENTAL

### Solubility—Example 1

An organic solvent, immiscible with or more volatile than the hydrocarbon, was sought as an easily removable vector for exchanging labile protons for nonvolatile Li cations to form anhydrous Li naphthenate dimers in petroleum. This would include lower alcohols, ethers, esters, aldehydes, and ketones. The solubility of each of two Li salts in several such solvents was determined by dissolving a known amount of salt in a known amount of solvent until precipitation was observed. The amount of precipitated salt was determined through a filtration method and the solubility calculated. The results are presented in Table I.

Based on these results, the most cost-effective and concentrated blend in organic solvent was 2% LiOH in methanol.

TABLE I
Solubility of Li₂CO₃ and LiOH in Organic Solvents

% Salt in solution

| Solvent | Li₂CO₃ | LiOH |
|---|---|---|
| Methanol | 0.08% | 1.98% |
| Acetone | 0.10% | 0.40% |
| Ethanol | 0.14% | 1.07% |
| Isopropyl alcohol | 0.12% | 0.02% |
| Methyl ethyl ketone | 0.12% | 0.02% |
| Butanol | 0.06% | 0.14% |
| Methyl isobutyl ketone | 0.10% | 0.00% |

### TAN Reduction—Examples 2-24

Seven samples of LACT (Local Automatic Custody Transfer) oil blended with the 2% lithium hydroxide in methanol solution were submitted for TAN testing to determine the amount of salt solution required to reduce TAN of the oil a given amount (Examples 2-8). Table II provides the measured TAN using ASTM method D 664-06 (Acid Number of Petroleum Products by Potentiometric Titration). As the amount of the LiOH Solution added to the crude increased, TAN of the oil decreased. TAN of <1 could thus be achieved (Example 8).

TABLE II
TAN Reduction with 2% LiOH in Methanol

| | Agitation | % Solution | LiOH added | Measured |
|---|---|---|---|---|
| Ex. | (min.) | added | (as TAN) | oil TAN |
| 2 | 5 | — | blank | 2.78 |
| 3 | 5 | 2 | 0.7 | 2.09 |
| 4 | 5 | 3 | 1.4 | 1.42 |
| 5 | 10 | 3 | 1.4 | 1.41 |
| 6 | 5 | 3 | 1.4 | 1.39 |
| 7 | 10 | 3 | 1.4 | 1.39 |
| 8 | 5 | 6 | 2.8 | 0.76 |

The 2% solution of LiOH in methanol (the best volatile organic solvent) succeeded in reducing TAN at 100% stoichiometric conversion. The TAN was so high, however, and the solution so dilute, that this treatment might involve removing an impractical amount of methanol. Although the cost of removing the methanol might be far less then the penalty for excess TAN, equipment might not be installed or available to do such a separation. The use of water as a vector would be advantageous, since equipment to separate it is already in operation.

Solutions of 10% LiOH in water (11% is the limit of solubility) were added and compared to equimolar solutions of a dissociating hydroxide, KOH. A wide spectrum of mixing energies was tested to determine application requirements. These results are presented in Table III. The 10% aqueous solutions were as effective as the methanol solution in reducing TAN below 1 over a wide range of mixing energies.

TABLE III
Aqueous LiOH/KOH TAN Reduction Mixing and Duration Response

| | | | | | | | | | Total Acid Number | | | |
|---|---|---|---|---|---|---|---|---|---|---|---|---|
| | | | | | | | | | (mg) | | | |
| Ex. | Treatment | Method | Power | Speed | Multiple | Unit | Store | Tests | 1 day | 1 wk. | 1 mo. | Notes |
| 9 | Li 1.4 TAN | Hand | Hard | 4 cps | 8 | times | no | TAN | 1.40 | | | |
| 10 | Li 1.4 TAN | Hand | Hard | 4 cps | 30 | times | no | TAN | 1.41 | | | |
| 11 | Li 1.4 TAN | Machine | High | 4 cps | 30 | seconds | no | TAN | 1.42 | | | |
| 12 | Blank | Machine | High | 4 cps | 2 | minutes | no | TAN | 2.79 | | | 1 |
| 13 | Blank | Machine | High | 4 cps | 2 | minutes | 1 wk. | TAN | | 2.76 | | 1 |
| 14 | Blank | Machine | High | 4 cps | 2 | minutes | 1 mo. | TAN | | | 2.78 | 1 |
| 15 | Li 1.4 TAN | Machine | High | 4 cps | 2 | minutes | no | TAN, emulsion | 1.42 | | | |
| 16 | Li 1.4 TAN | Machine | High | 4 cps | 2 | minutes | no | TAN, emulsion | 1.44 | | | 2 |
| 17 | Li 1.4 TAN | Machine | High | 4 cps | 2 | minutes | 1 wk. | TAN, emulsion | | 1.40 | | 2 |
| 18 | Li 1.4 TAN | Machine | High | 4 cps | 2 | minutes | 1 mo | TAN, emulsion | | | 1.40 | 2 |
| 19 | K 1.4 TAN | Machine | High | 4 cps | 2 | minutes | no | TAN, emulsion | 1.48 | | | |
| 20 | K 1.4 TAN | Machine | High | 4 cps | 2 | minutes | no | TAN, emulsion | 1.50 | | | 3 |
| 21 | K 1.4 TAN | Machine | High | 4 cps | 2 | minutes | 1 wk. | TAN, emulsion | | 1.52 | | 3 |
| 22 | K 1.4 TAN | Machine | High | 4 cps | 2 | minutes | 1 mo. | TAN, emulsion | | | 1.51 | 3 |
| 23 | Li 1.4 TAN | Machine | High | 4 cps | 8 | minutes | no | TAN | 1.42 | | | |
| 24 | Li 1.4 TAN | Homogenizer | Full | 29k rpm | 4 | seconds | no | TAN | 1.43 | | | |

Appearance Notes for Emulsion Break Shaken with 50% Water
1 = clear water, thick baggy I/F (interface), fastest shake recovery
2 = clear water, thin reverse at I/F, medium shake recovery
3 = hazy water, reverse at I/F, slowest recovery

### Process Compatibility

The samples of treated oil were also set aside for long-term TAN reduction and process compatibility, in particular the formation of emulsifying soaps.

Emulsification tests were run immediately after addition of the reagents, as well as 1 week and 1 month later. Table III describes the effect of the LiOH on the emulsification of water and oil and compares it to no treatment (Examples 12-14) and to the addition of equal molar amounts of a non-associating alkali metal hydroxide, KOH (Examples 19-22).

Shaken with equal parts of water, the LiOH-treated oil broke out all the water, and the water was clear, with only a thin layer of reverse emulsion at the interface, and the oil was bright, with no visible impurities (Examples 16-18). The untreated oil separated the bulk phases faster, and kept what water could be seen clear, but only about half the water could be seen; the rest was a thick pad of baggy emulsion at the interface (Examples 12-14). The KOH treated oil broke out much slower than the LiOH treated oil and made the water hazy, to the point that features on the far side of the bottle could not be discerned (Examples 20-22). The LiOH-treated oil maintained all of its initial TAN reduction and demulsification effect after one month of storage.

### Effect of 2 TAN of LiOH on Distillation Fractions

Oil treated with 10% LiOH was dewatered (Method 1 below) then distilled to a 560° F. (290° C.) vapor temperature. The input temperature to drive this distillation was ˜1300° F. (˜700° C.). This distillation was intended to simulate the 600-800° F. (320-430° C.) liquid temperature used to produce heavy gas oil for catalytic cracking. The distillate and residual bottoms left from the distillation were then analyzed for TAN and metals by ICP (Inductively Coupled Plasma atomic adsorption spectroscopy).

The results show that both the acid and the Li stayed with the heavier bottom fraction (see table below) and did not show up in the distillate. The TAN of the distillate was about half that of the bottoms, and it contained <1 ppm of Li when the bottoms contained 263 ppm. And this despite the fact that even non-volatile Na and Si made it into the overhead. Thus, Li naphthenate does not dissociate or metathesize to naphthenic acid at these temperatures.

TABLE IV
TAN and Metals in Fractionated Crude Oil Treated with LiOH

| Fraction | TAN* | Li | Na | Mg | Ca | Fe | Cu | Zn | Ni | V | Si | P |
|---|---|---|---|---|---|---|---|---|---|---|---|---|
| Distillate | 0.15 | <1 | 1.2 | <1 | <1 | <1 | 3.4 | 1 | <1 | <1 | 3.9 | 2.6 |
| Bottoms | 0.28 | 263 | 58.0 | 1.7 | 8.1 | 3.0 | <1 | <1 | 12.0 | 11.0 | 14.0 | 2.0 |

*Total Acid Number, mg KOH/g. Metals, by ICP, are in ppm.

### Distillation Prep Method 1

1) Add 2 Tan of LiOH as 10% aq. solution to produced fluids
2) Hand shake 200 times
3) Settle at 100° F. (38° C.) for 72 hours
4) Draw off top oil and run desalter simulation test using 5% wash water.
5) Draw off the top oil and centrifuge oil with demulsifier for 20 minutes
6) Distill oil to a 560° F. (290° C.) vapor temperature, an input temperature of 1300° F. (700° C.).
7) Analyze distillate and undistilled bottoms for TAN and for Li by Inductively Coupled Plasma (ICP) Atomic Adsorption Spectroscopy.

### Effect of Li in Residual Oil

The residue of distillation is typically used to make coke. The actual effect of Li on coke quality is not known, as it is not naturally there. It is known that excessive amounts of other alkali metals, such as Na, make coke unsuitable for use as anodes in the electrolytic production of Al. This is a high value but small volume application. It is not known if Li would cause a similar problem—unlike Na, Li is added to Al to strengthen aeronautical grade alloys. Metallurgical grade coke, used to make steel, is tolerant of alkali metal impurities, which end up in the slag. Fuel grade coke is also tolerant of metals.

### Economics of TAN Downgrading

Oil traders discount crude oil with higher TAN. This drastically affects the economic of producing such crude. This discount can be rationalized with the following breakdown of extra costs per TAN:

TABLE V
Economics of TAN Downgrading

| | |
|---|---|
| Technical Discount | $0.50–0.55/bbl |
| Treating cost | $0.20/bbl |
| Blending cost | $0.15–0.20/bbl |
| Metallurgical cost | $0.15/bbl |
| Expected total discount | $1.00–2.50/bbl |
| Total Market Discount | $1.00–2.00/bbl |

In the foregoing specification, the invention has been described with reference to specific embodiments thereof. It has been demonstrated as effective in providing methods and compositions for reducing the acidic potential, as measured by TAN, of hydrocarbons, particularly crude oil. However, it will be evident that various modifications and changes can be made thereto without departing from the broader spirit or scope of the invention as set forth in the appended claims. Accordingly, the specification is to be regarded in an illustrative rather than a restrictive sense. For example, specific combinations of monovalent metal hydroxides, polyvalent metal hydroxides, monomeric ammonium hydroxides, monomeric and/or polymeric 4° ammonium hydroxides and their corresponding oxides, carbonates and the thio and alkyl analogs of such, other components falling within the claimed parameters, but not specifically identified or tried in a particular composition or under specific conditions, are anticipated to be within the scope of this invention.

What is claimed is:

1. A method for reducing acidic potential, as measured by total acid number (TAN), of a hydrocarbon comprising:
contacting a mixture of the hydrocarbon and a non-hydrocarbon phase with a reagent comprising a monovalent or a polyvalent metal hydroxide, or monomeric or polymeric 4° ammonium hydroxide, or the corresponding oxide, carbonate and thio and alkyl analog of these hydroxides, in an amount effective to reduce TAN, such that the reagent is at least partly converted into a material of the non-hydrocarbon phase; and
removing the non-hydrocarbon phase in an amount sufficient to reduce the acidic potential of the hydrocarbon.

2. The method as in claim 1 where the acidic potential is the ability or tendency to form acidic species in subsequent storage, transport, or processing of the hydrocarbon.

3. The method of claim 1 where the effective amount of the reagent is at least equivalent to 0.1 mg KOH/g sample.

4. The method of claim 1 where the effective amount of reagent is sufficient to reduce the TAN to between about 0.1 and about 0.9 mg KOH/g sample.

5. The method of claim 1 where the reagent is a monovalent or polyvalent metal hydroxide, or monomeric or polymeric 4° ammonium hydroxide.

6. The method of claim 3 where the reagent is a monovalent or polyvalent metal hydroxide, or monomeric or polymeric 4° ammonium hydroxide.

7. The method of claim 1 where the reagent is lithium hydroxide.

8. The method of claim 7 where contacting the hydrocarbon with the lithium hydroxide is with the hydroxide in a solution of methanol or water.

9. The method of claim 1 where the non-hydrocarbon phase is selected from the group consisting of water, CO₂, H₂S, lower alcohols, ethers, esters, aldehydes, ketones and mixtures thereof immiscible with or more volatile than the hydrocarbon.

10. The method of claim 9 where the lower alcohols, ethers, esters, aldehydes, and ketones are selected from the group consisting of methanol, ethanol, propanol, butanol, acetone, methyl ethyl ketone, methyl isobutyl ketone and mixtures thereof.

11. The method of claim 1 in which the non-hydrocarbon phase is immiscible with the hydrocarbon and removed therefrom in a liquid-liquid separator.

12. The method of claim 1 in which the non-hydrocarbon phase is more volatile than the hydrocarbon and removed in a liquid-gas separator.

13. The method of claim 1 where the hydrocarbon containing the reagent has a reduced tendency to form emulsion as compared with an identical hydrocarbon without the reagent.

14. The method of claim 1 where the reagent is a monovalent metal compound and the hydrocarbon containing it has a reduced tendency to form deposits as compared with an identical hydrocarbon without the reagent.

15. A method for reducing acidic potential, as measured by total acid number (TAN), of a hydrocarbon comprising:
contacting a mixture of the hydrocarbon and water with lithium hydroxide in an amount at least equivalent to 0.1 mg KOH/g sample to reduce the TAN thereby converting the hydroxide of the metal to water; and
removing the water.

16. The method of claim 15 where the amount of lithium hydroxide is sufficient to reduce the TAN to between about 0.1 and about 0.9 mg KOH/g sample.

17. The method of claim 15 where contacting the hydrocarbon with the lithium hydroxide is with the hydroxide in a solution of methanol or water.

18. The method of claim 15 in which the water is removed in a liquid-liquid oil-water separator.

19. The method of claim 15 where the hydrocarbon containing the additive has a reduced tendency to form emulsion as compared with an identical hydrocarbon without the lithium hydroxide added.

20. The method of claim 15 where the hydrocarbon containing the additive has a reduced tendency to form deposits as compared with an identical hydrocarbon without the lithium hydroxide added.

21. A hydrocarbon composition having a reduced acidic potential, as measured by total acid number (TAN), comprising:
a hydrocarbon; and
a non-hydrated (anhydrous), metal or 40 ammonium acid anion or a dimer thereof,
where the composition is relatively more stable toward precipitation from the hydrocarbon, emulsification of the hydrocarbon, and/or breakdown to regenerated acid, compared to an otherwise identical hydrocarbon containing hydrated (hydrous) metal or 4° ammonium acid anion.

22. The hydrocarbon composition of claim 21 where the amount of non-hydrated, metal or 4° ammonium acid anion is at least equivalent to 0.1 mg KOH/g sample.

23. The hydrocarbon composition of claim 21 where the metal in the non-hydrated metal or 4° ammonium acid anion is a non-hydrated lithium acid anion.

24. The hydrocarbon composition of claim 23 where the non-hydrated, lithium acid anion is introduced into the hydrocarbon as lithium hydroxide, oxide, carbonate, or their thio and alkyl analogs, in a solvent immiscible with or more volatile than the hydrocarbon.

25. The hydrocarbon composition of claim 24 where the non-hydrated, lithium acid anion is introduced as lithium hydroxide and the solvent is methanol or water.

26. A hydrocarbon composition having a reduced acidic potential, as measured by total acid number (TAN), comprising:
a hydrocarbon; and
a non-hydrated (anhydrous) lithium anion in an amount at least equivalent to 0.1 mg KOH/g sample,
where the composition is relatively more stable toward precipitation from the hydrocarbon, emulsification of the hydrocarbon, and/or breakdown to regenerated acid, compared to an otherwise identical hydrocarbon containing hydrated (hydrous) lithium-acid anion.

27. The hydrocarbon composition of claim 26 where the non-hydrated (anhydrous) lithium acid anion is introduced into the hydrocarbon as lithium hydroxide or equivalent in a solution of methanol or water.
